(19) United States
(12) Patent Application Publication
(10) Pub. No.: US 2004/0243889 A1
(43) Pub. Date: Dec. 2, 2004

(54) N-dimensional determination of bit-error rates

(76) Inventors: Peng Li, Palo Alto, CA (US); Jan Brian Wilstrup, Mounds View, MN (US); John David Hamre, Plymouth, MN (US)

Correspondence Address: Merchant & Gould P.C., P.O. Box 2903, Minneapolis, MN, 55402-0903, US

(21) Appl. No.: 10/765,271

(22) Filed: Jan. 27, 2004

Related U.S. Application Data
(60) Provisional application No. 60/443,238, filed on Jan. 27, 2003.

(51) Int. Cl. G06F 11/00

(52) U.S. Cl. 714/704

(57) ABSTRACT

A method for measuring a bit error rate in a communication system that includes a transmitter, a medium, and a receiver. The method may include identifying a plurality of causes of bit errors. For each cause, the communication system is measured to determine a corresponding probability density function. Each of the corresponding probability density functions is integrated over an interval representing a range in which the corresponding cause creates a bit error, thereby generating a plurality of integrated quantities. The integrated quantities are summed to arrive at a bit error rate for the communication system. An apparatus may be programmed to execute the foregoing method.

### RELATED APPLICATIONS

This application claims priority of U.S. provisional application Ser. No. 60/443,238, filed Jan. 27, 2003 and entitled “N-DIMENSIONAL DETERMINATION OF BIT ERROR RATES.”

### TECHNICAL FIELD

This invention relates generally to the field of bit-error rate measurement and more particularly to a scheme by which bit-error rates may be mapped into a plurality of dimensions.

### BACKGROUND

A communication system is broadly thought to contain three major subsystems: a transmitter, a medium, and a receiver. The transmitter typically modulates a signal with a set of data, and thereafter propagates the modulated signal along the medium to the receiver. The receiver is responsible for recovering the modulated data. In the context of digital communications, the receiver is responsible for correctly determining if a received symbol represents a “1” or a “0”.

Conventionally, digital communication systems are synchronous, meaning that that the symbols representative of “1's” or “0's” are expected to arrive at the receiver within a given window of time. For example, a receiver may attempt to determine whether an incoming symbol represents a “1” or a “0” by sampling the voltage of the received signal at a given point in time (referred to as the sampling time). If the sampled voltage exceeds a prescribed threshold, the symbol is regarded as a “1”, otherwise the symbol is regarded as a “0”.

The above-described task of data recovery is subject to many forms of error. For example, a symbol intended to represent a “1” may simply fail to be of sufficient amplitude to exceed the aforementioned threshold. Consequently, such a symbol would incorrectly be regarded as a “0”. Such an occurrence is referred to as a bit error. Communication systems are judged based upon their bit error rates, the frequency with which a bit error is expected to occur.

It is known that many factors influence bit error rate. For example, amplitude jitter (i.e., the phenomenon described above, whereby at the receiver a signal is either greater or lesser in amplitude than intended) is known to influence bit error rate—typically the greater the amplitude jitter, the greater the bit error rate. Timing jitter is also known to influence bit error rates. Many other factors are also known to influence bit error rates.

Although it is known that the bit error rate of a communication system is a function of many variables (e.g., amplitude jitter, timing jitter, baseline wander, etc.), present techniques for measuring and/or describing bit error rates fail to describe them as a function of more than one variable. Such a state of affairs presents difficulty to individuals charged with the task of designing communication systems. For example, such an individual may desire to know what level of timing jitter will yield a bit error rate of 1*10⁻¹² if a given level of amplitude jitter is permitted to exist. A one-dimensional approach to describing bit error rates clearly does not lend itself to answering such questions.

For at least the foregoing reasons, there exists a need for a scheme by which a bit error rate may be described as a function of more than one variable. A successful scheme will require relatively little system measurement time and will yield relatively accurate results.

### SUMMARY OF THE INVENTION

Against this backdrop the present invention was developed. A method of measuring a bit error rate in a communication system which includes a transmitter, a medium, and a receiver may involve identifying a plurality of causes of bit errors. For each cause, the communication system is measured to determine a corresponding probability density function. Each of the corresponding probability density functions is integrated over an interval representing a range in which the corresponding cause creates a bit error, thereby generating a plurality of integrated quantities. The integrated quantities are summed to arrive at a bit error rate for the communication system.

According to another embodiment of the invention, an apparatus for determining a bit error rate in a communication system may include a measurement apparatus for measuring the communication system to determine probability density functions corresponding to a plurality of causes of bit errors. The apparatus may also include an analyzing unit, operatively connected to the measurement apparatus, for integrating each of the probability density functions over an interval representing a range in which the corresponding cause creates a bit error, thereby generating a plurality of integrated quantities and summing the integrated quantities to arrive at a bit error rate for the communication system.

According to yet another embodiment of the invention, a program storage medium readable by a computer having a memory and embodying one or more programs of instructions executable by the computer to perform method steps for performing operations to arrive at a bit error rate for a communication system may include the following steps. For each of a plurality of causes of bit errors, measuring the communication system to determine a corresponding probability density function. Integrating each of the corresponding probability density functions over an interval representing a range in which the corresponding cause creates a bit error, thereby generating a plurality of integrated quantities. Summing the integrated quantities to arrive at a bit error rate for the communication system.

### BRIEF DESCRIPTION OF THE DRAWINGS

FIG. 1A depicts an ideal symbol that is representative of a “1”.

FIG. 1B depicts a symbol, representative of a “1”, that has been delayed in time.

FIG. 1C depicts a probability density function of timing jitter.

FIG. 2A depicts an ideal symbol that is representative of a “1”.

FIG. 2B depicts a symbol, representative of a “1”, that has been advanced in time.

FIG. 2C depicts a probability density function of timing jitter.

FIG. 3A depicts an ideal symbol that is representative of a “1”.

FIG. 3B depicts a symbol, with insufficient amplitude, that is intended to represent a “1”.

FIG. 3C depicts a probability density function of amplitude jitter.

FIG. 4A depicts an ideal symbol that is representative of a “0”.

FIG. 4B depicts a symbol, with extraneous amplitude, that is intended to represent a “0”.

FIG. 4C depicts a probability density function of amplitude jitter.

FIG. 5 depicts a bit error rate topology that is a function of two variables.

FIG. 6 depicts a system for measuring a probability density function of any cause of bit errors.

FIG. 7 depicts an exemplary hardware environment for a measuring a bit error rate of a communication system, according an embodiment of the present invention.

### DETAILED DESCRIPTION

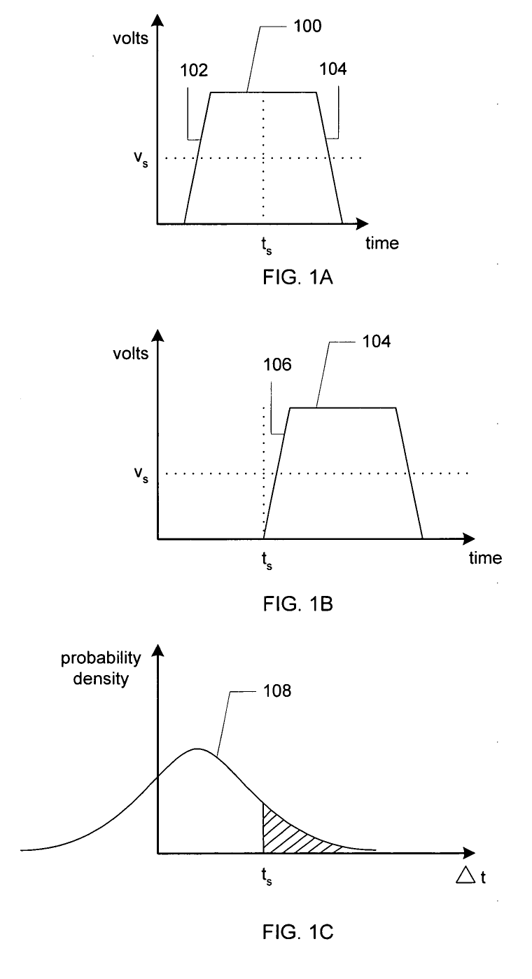

FIG. 1A depicts a waveform 100 plotted against time (on the x axis). Although the y axis is labeled “volts,” it is understood that a waveform may consist of any time-varying physical characteristic observed against time. For the sake of discussion, waveforms herein are described as exhibiting a voltage that varies with time.

As can be seen from FIG. 1A, the waveform 100 includes a leading edge 102 and a trailing edge 104. The waveform is sampled at time=tₛ, which is also referred to herein as the sampling time. For the sake of this discussion, the waveform is assumed to be received by a receiver (not depicted in FIG. 1A) that recovers data as follows. If the sampled voltage (i.e., the voltage exhibited by the waveform 100 at the sampling time) exceeds the threshold voltage (vₛ), the waveform 100 is regarded as representative of a “1”, otherwise the waveform 100 is regarded as representative of a “0”. Per such a scheme, waveform 100 is regarded as representative of a “1”.

FIG. 1B depicts a waveform 104, the arrival of which at the receiver is tardy. Notably, the leading edge 106 of the waveform 104 does not depart from the x axis until time=tₛ, the sampling time. Consequently, the tardy waveform 104 exhibits a voltage that is less than the threshold voltage vₛ at the sampling time (in this case, the sampled voltage is 0 volts, which is clearly less than vₛ). Waveform 104 is therefore incorrectly regarded as representing a “0” instead of representing a “1”. Waveform 104 illustrates but one example of a bit error caused by a leading edge 106 that is delinquent in crossing the threshold vₛ. When a bit error is caused by such a delinquency, the bit error is said to be caused by timing jitter.

To understand the contribution of this form of timing jitter—delinquent transition of a waveform edge—to a bit error rate, it is important to understand the probability of such an event occurring. The probability density function depicted in FIG. 1C graphically illustrates the probability of a delinquent waveform edge causing a bit error.

FIG. 1C depicts a probability density function 108, which is plotted against timing jitter (Δt) on the x axis (probability density is, of course, on the y axis). Timing jitter, Δt, is defined as the difference between when an actual waveform edge crosses the threshold, vₛ, and when an ideal waveform edge would cross the threshold. Thus, tₛ in FIG. 1C does not represent the same numeric value that tₛ in FIG. 1A represents. Instead, tₛ of FIG. 1C represents the difference between the numeric values of tₛ in FIG. 1A and the time at which that leading edge 102 therein crossed the threshold, vₛ.

The probability that delinquent transition of a waveform edge would cause a bit error is identified by the shaded region in FIG. 1C. That this is the case can be confirmed by the simple understanding that if the waveform edge does not cross the threshold by time=tₛ, then the waveform will be mistakenly identified. Thus, all timing jitter of a leading edge greater than t, necessarily causes a bit error. The area identified by the cross-hatching (i.e., the probability that a bit error is caused by a delinquent waveform edge) is given by:

$${P}_{01} {\int }_{{t}_{s}}^{∞} p ( Δ t , Δ v = 0 , t = {t}_{s} ) ⅆ Δ t , \qquad [ 1 ]$$

where: P₀₁ represents the probability of a transition from a “0” to a “1”; Δv represents amplitude jitter (discussed herein, below), which is assumed to be absent; t represents the sampling time, which is assumed to be ideal, i.e., tₛ; and wherein the function “p” represents the probability density function 108 of FIG. 1C, which assumes no amplitude or sampling jitter.

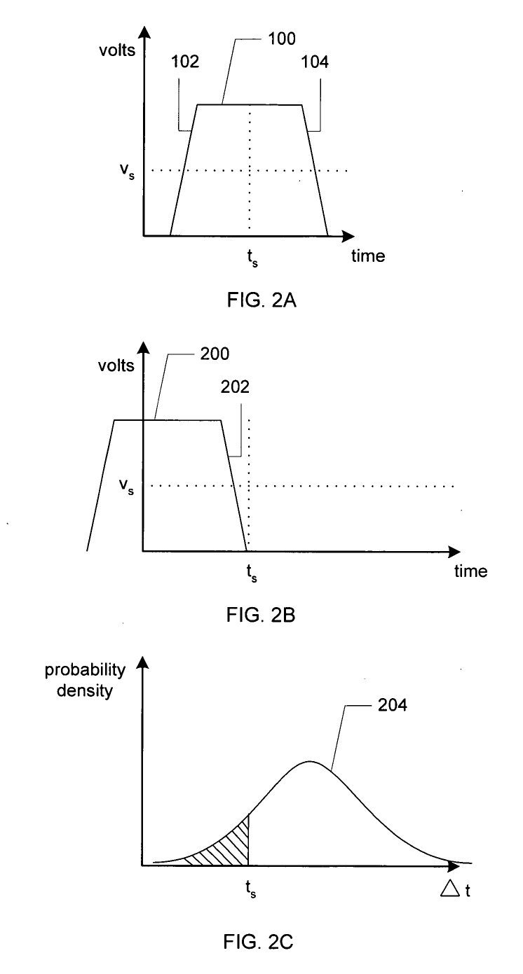

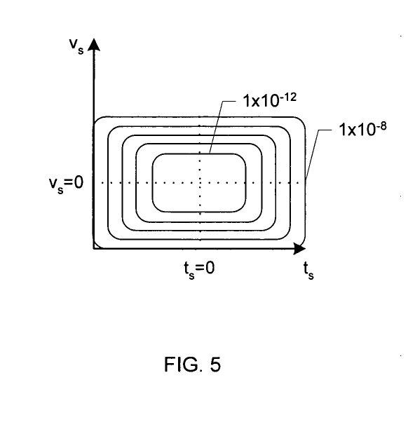

The discussion associated with FIGS. 2A-C, 3A-C, and 4A-C is devoted to identifying the independent contribution of three other causes of bit error (early transition of a waveform edge, insufficient symbol amplitude, and extraneous symbol amplitude) to the overall bit error rate. A portion of the remaining discussion focuses creating a bit error rate function that is a function of two variables: timing jitter (waveform transition delinquent or early), and amplitude jitter (symbol amplitude insufficient or extraneous). Such discussion is illustrative of a broader principle of construction of a bit error rate function of any number of variables representing any number of causes. The schemes discussed herein may be implemented by a measurement environment depicted and discussed in FIG. 5.

FIG. 2A depicts an ideal waveform representation of a “1”. FIG. 2A is therefore identical to FIG. 1A (it depicts a waveform 100 having a leading edge 102 and a trailing edge 104), and is presented on this sheet of figures for ease of reference for the reader.

FIG. 2B depicts a waveform 200, the arrival of which at the receiver is early. Notably, the trailing edge 202 of the waveform 200 returns to the x axis at time=tₛ, the sampling time. Consequently, the premature waveform 200 exhibits a voltage that is less than the threshold voltage vₛ at the sampling time (in this case, the sampled voltage is 0 volts, which is clearly less than vₛ). Waveform 200 is therefore incorrectly regarded as representing a “0” instead of representing a “1”. Waveform 200 illustrates but one example of a bit error caused by a trailing edge 106 that is premature in crossing the threshold, vₛ. As in the example described in FIGS. 1A-C, this bit error is said to be caused by timing jitter.

The probability that premature transition of a waveform edge would cause a bit error is identified by the shaded region in FIG. 2C. That this is the case can be confirmed by the simple understanding that if the waveform edge crosses the threshold prior to time=tₛ, then the waveform will be mistakenly identified. Thus, all timing jitter of a trailing edge less than tₛ necessarily causes a bit error. The area identified by the cross-hatching (i.e., the probability that a bit error is caused by a delinquent waveform edge) is given by:

$${P}_{10} {\int }_{- ∞}^{{t}_{s}} p ( Δ t , Δ v = 0 , t = {t}_{s} ) ⅆ Δ t , \qquad [ 2 ]$$

where: P₁₀ represents the probability of a transition from a “1” to a “0”; and wherein the function “p” represents the probability density function 204 of FIG. 2C, which assumes no amplitude or sampling jitter.

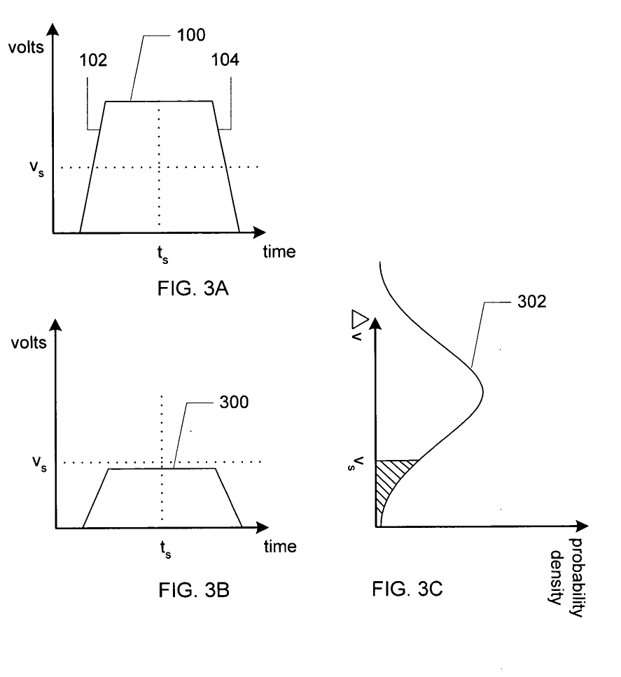

As was the case with FIG. 2A, FIG. 3A depicts an ideal waveform representation of a “1”. Again, FIG. 3A is therefore identical to FIG. 1A (it depicts a waveform 100 having a leading edge 102 and a trailing edge 104), and is presented on this sheet of figures for ease of reference for the reader.

FIG. 3B depicts a waveform 300, the amplitude of which is insufficient. As can be seen from FIG. 3B, the waveform 300 fails to cross the threshold vₛ. Thus, because the sampled voltage is less than vₛ, the symbol 300 is improperly interpreted as being representative of a “0”, instead of a “1”. Waveform 300 exhibits but one example of amplitude jitter.

FIG. 3C depicts a probability density function 302, which represents the probability density for a symbol exhibiting a range of amplitude jitters (amplitude jitter, Δv, is on the y axis, and probability density is on the x axis). The probability that insufficient amplitude of a waveform would cause a bit error is identified by the shaded region in FIG. 3C. That this is the case can be confirmed by the understanding that if the waveform amplitude fails to cross the threshold at time=tₛ, then the waveform will be mistakenly identified. Thus, all amplitude jitter less than vₛ (if carried on a “1”) necessarily causes a bit error. The area identified by the cross-hatching (i.e., the probability that a bit error is caused by a delinquent waveform edge) is given by:

$${P}_{1} {\int }_{- ∞}^{{v}_{s}} p ( Δ t = 0 , Δ v , t = {t}_{s} ) ⅆ Δ v , \qquad [ 3 ]$$

where: P₁ represents the probability of a “1”; Δt represents timing jitter, which is assumed to be absent; Δv represents amplitude jitter; t represents the sampling time, which is assumed to be ideal, i.e., tₛ; and wherein the function “p” represents the probability density function 302 of FIG. 3C, which assumes no timing or sampling jitter.

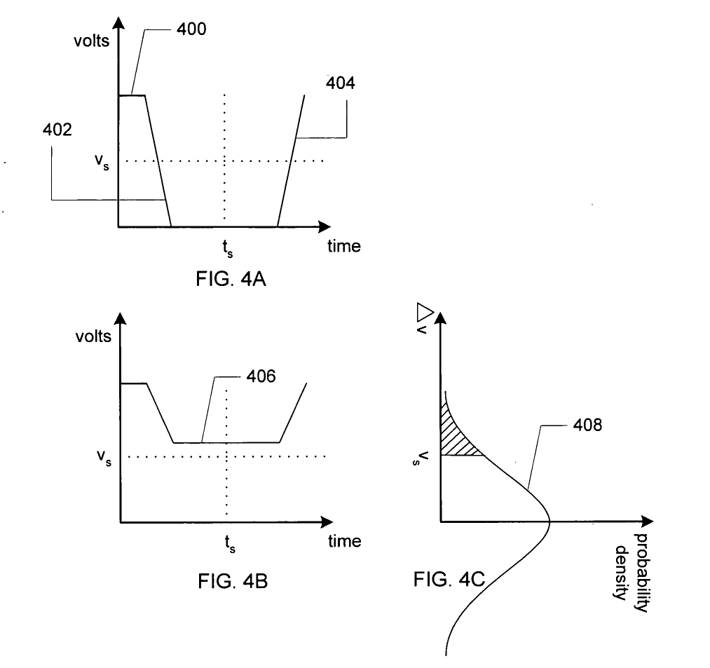

FIG. 4A depicts an ideal waveform 400, which is representative of a “0”. As with the previously depicted waveforms, waveform 400 includes a leading edge 402 and a trailing edge 404.

FIG. 4B depicts a waveform 406, the amplitude of which is extraneous. As can be seen from FIG. 4B, the waveform 406 mistakenly crosses the threshold vₛ. Thus, because the sampled voltage is greater than vₛ, the symbol 406 is improperly interpreted as being representative of a “1”, instead of a “0”. Waveform 406 exhibits but one example of amplitude jitter.

FIG. 4C depicts a probability density function 408, which represents the probability density for a symbol exhibiting a range of amplitude jitters (amplitude jitter, Δv, is on the y axis, and probability density is on the x axis). The probability that extraneous amplitude of a waveform would cause a bit error is identified by the shaded region in FIG. 4C. That this is the case can be confirmed by the understanding that if the waveform amplitude crosses the threshold at time=tₛ, then the waveform will be mistakenly identified. Thus, all amplitude jitter greater than vₛ (if carried on a “0”) necessarily causes a bit error. The area identified by the cross-hatching (i.e., the probability that a bit error is caused by a delinquent waveform edge) is given by:

$${P}_{0} {\int }_{{v}_{s}}^{∞} p ( Δ t = 0 , Δ v , t = {t}_{s} ) ⅆ Δ v , \qquad [ 4 ]$$

where: P₀ represents the probability of a “0”; Δt represents timing jitter, which is assumed to be absent; Δv represents amplitude jitter; t represents the sampling time, which is assumed to be ideal, i.e., tₛ; and wherein the function “p” represents the probability density function 408 of FIG. 4C, which assumes no timing or sampling jitter.

The preceding discussion has revealed the independent contribution of timing jitter (waveform transition delinquent or early) and amplitude jitter (symbol amplitude insufficient or extraneous) to the overall bit error rate. Therefore, the overall bit error rate may be arrived at by summation of each of the independent constituent contributors:

$$bit error rate = {P}_{01} {\int }_{{t}_{s}}^{∞} p ( Δ t , Δ v = 0 , t = {t}_{s} ) ⅆ Δ t + {P}_{10} {\int }_{- ∞}^{{t}_{s}} p ( Δ t , Δ v = 0 , t = {t}_{s} ) ⅆ Δ t + {P}_{1} {\int }_{- ∞}^{{v}_{s}} p ( Δ t = 0 , Δ v , t = {t}_{s} ) ⅆ Δ v + {P}_{0} {\int }_{{v}_{s}}^{∞} p ( Δ t = 0 , Δ v , t = {t}_{s} ) ⅆ Δ v . \qquad [ 5 ]$$

In other words, the overall bit error rate is equal to the probability that a bit error is caused by a waveform edge transitioning too early, plus the probability that a waveform edge arrives too late, plus the probability that a waveform is of insufficient amplitude, plus the probability that a waveform is of extraneous amplitude.

Assuming that each of the four probability density functions used in the overall bit error rate calculation is known (their determination is discussed below), then the overall bit error rate may be found for any combination of tₛ and vₛ. Stated another way, the overall bit error rate is a function of the integration boundaries used in the above-stated formula for overall bit error rate.

By “plugging in” a plurality of combinations of values into the above-stated formula for overall bit error rate (equation 5), a topology is created whereby bit error rate is viewed as a surface. A hypothetical topology is presented in FIG. 5, wherein lines plotted on the tₛ-vₛ coordinate axis represent points having equal bit error rates. As can be seen from FIG. 5, as timing jitter and voltage jitter are reduced, bit error rates drop (e.g., the bit error rate drops below 1×10⁻¹²). A topology such as FIG. 5 may be used by an individual designing a communication system to answer a question such as what level of timing jitter is acceptable if a given level of amplitude jitter is permitted to exist, and the system is required to have an overall bit error rate of less than a particular value. States more broadly, by calculating bit error rate as a function of many variables (each representative of a separate cause of bit error rate), any number of variables may be held constant while others are permitted a range of values so that a hypothetical bit error rate can be presented. For example if bit error rate were to be calculated as a function of four variables (e.g., timing jitter, amplitude jitter, baseline wander, and interference level), then timing and amplitude jitter may be assigned known values, while baseline wander and interference levels are permitted a range of values. Bit error rate could then be depicted as a topology defined by baseline wander and interference level, in a manner analogous to that which has been depicted in FIG. 5.

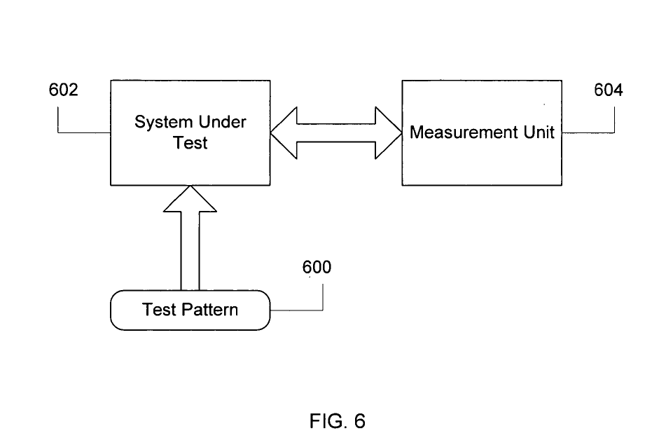

The probability density functions used in equation 5 may be found by direct observation. For example, as shown in FIG. 6, a known sequence of data 600 may be transmitted through a communication system 602. A measurement unit 604 may be used to measure timing jitter, for example. The measurement unit may be, for example, a Wavecrest SIA3000 unit. A histogram representing various levels of timing jitter may be created based upon observed retardation or prematurely of waveform edges. The histogram may thereafter be normalized, thereby creating a probability density function.

An alternative method of determining the probability density functions used in equation 5 exists. To illustrate, it is assumed that the probability density function for tardy arrival of a waveform edge is desired (one skilled in the art understands that the method described below has applicability to determining any probability density function that is expected to be gaussian in nature). The alternative technique involves identifying a tail portion of a probability density function and fitting such a tail portion to a known function, such as a gaussian function. By doing so, a complete probability density function may be arrived at. Such a technique is disclosed in U.S. Pat. No. 6,298,315, which is hereby incorporated by reference for all it teaches. Alternatively, a partially arrived at cumulative distribution function may be fit to a known function, such as an error function. By doing so, a complete probability distribution function may be arrived at.

A portion of the above-mentioned probability density function may be found, for example, by delaying the sampling time by a known amount. A known signal is transmitted through the communication system under test and is received by the receiver (utilizing the delayed sampling time). Occurrences of bit errors are recorded. For each occurrence of a bit error, it is known that the timing jitter must have exceeded the amount by which the sampling time was delayed. The number of bit error is recorded and associated with the amount by which the sampling time was delayed. The sampling time is then delayed by slight more time, and the occurrence of bit errors is again observed and recorded. By repeating this process several times, a set of ordered pairs (delay of sample time, number of bit errors observed) may be created. By plotting the ordered pairs on a coordinate plane, a portion of a cumulative density function is created. This curve may be fit to an integrated gaussian function, using a technique analogous to that described in U.S. Pat. No. 6,298,315. Alternatively, the derivative of this curve may be found (creating a partial probability density function), and then fit to a gaussian distribution, using the technique described in U.S. Pat. No. 6,298,315. The gaussian function to which the curve is fit is the probability density function sought.

It is understood that in lieu of integrating probability density functions corresponding to independent contributors to bit errors, cumulative density functions may be accessed to directly arrive at probability values corresponding to the likelihood that one of the independent contributors will create a bit error.

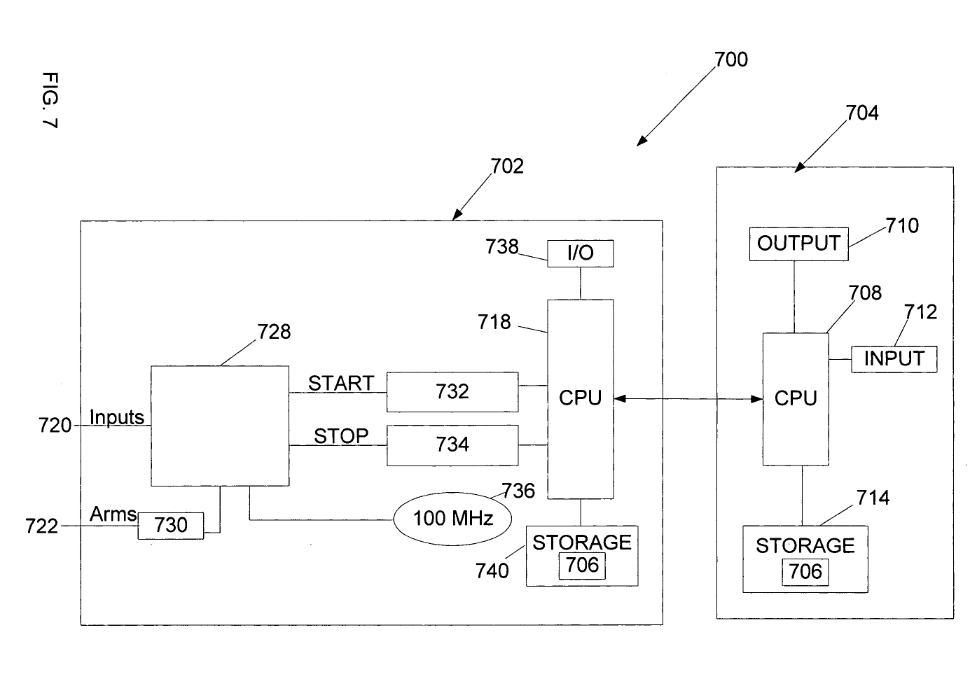

The methods, schemes, and techniques described herein may be implemented by a measurement system that is capable of measuring a time-varying physical characteristic of wave. An example of such a system is described in FIG. 7.

FIG. 7 is an exemplary illustration of a representative hardware environment for a bit error rate measuring system 700 according an embodiment of the present invention. A typical configuration may include a measurement apparatus 702 that measures the time interval between two events (start and stop) through counters. A measurement apparatus is disclosed in U.S. Pat. No. 4,908,784, which is hereby incorporated by reference. A typical measurement apparatus is the Wavecrest DTS-2075, available from Wavecrest Corporation, Edina, Minn.

Those skilled in the art will recognize that other systems that enable signal/distribution analysis that are based on real world measurement (i.e., measurements that are non-ideal or subject to uncertainty) would be applicable. Generally, this would include any product that can act as a distribution source. These devices include an oscilloscope, Automated Test Equipment (ATE), spectrum analyzer, network analyzer, TIA (time interval analyzer), universal time frequency counter, and modulation domain analyzer. Other devices may include a CCD, an x-ray camera, a MRI, and an ultrasound.

The measurement apparatus 702 interfaces to a workstation 704 and operates under the control of an analysis program 706 resident on the workstation 704. The analysis program 706 is typically implemented through data analysis software. One commercially available analysis software is the Wavecrest Virtual Instrument (VI) software, available from Wavecrest Corporation, Edina, Minn. Other analysis software includes LABVIEW, MathCad, MATLAB, Mathematica, among others. The workstation 704 comprises a processor 708 and a memory including random access memory (RAM), read only memory (ROM), and/or other components. The workstation 704 operates under control of an operating system, such as the UNIX.RTM. or the Microsoft.RTM. Windows NT operating system, stored in the memory to present data to the user on the output device 710 and to accept and process commands from the user via input device 712, such as a keyboard or mouse.

The analysis program 706 of the present invention is preferably implemented using one or more computer programs or applications executed by the workstation 704. Those skilled in the art will recognize that the functionality of the workstation 704 may be implemented in alternate hardware arrangements, including a configuration where the measurement apparatus 702 includes CPU 718, memory 740, and I/O 738 capable of implementing some or all of the steps performed by the analysis program 706. Generally, the operating system and the computer programs implementing the present invention are tangibly embodied in a computer-readable medium, e.g. one or more data storage devices 714, such as a zip drive, floppy disc drive, hard drive, CD-ROM drive, firmware, or tape drive. However, such programs may also reside on a remote server, personal computer, or other computer device.

The analysis program 706 provides for different measurement/analysis options and measurement sequences. The analysis program 706 interacts with the measurement apparatus 702 through the on-board CPU 718. In one embodiment, the measurement apparatus 702 provides arming/enabling functionality such that the apparatus 702 can measure a signal either synchronously or asynchronously. The signal is fed to the channel input arming/enabling controls 720 and 722 to which event that a measurement is made. Counter/interpolators 728, 730, and 732 measure the time elapse between the start and stop events. Interpolators provide fine time resolution down to 0.8 ps. In response to input controls 720 and 722 multiplexer 734 controls the counter/interpolators 728, 730, and 732 based on a clock 736 signal. Clock 736 is typically a precise crystal oscillator.

Those skilled in the art will recognize that the exemplary environment illustrated in FIG. 7 is not intended to limit the present invention. Indeed, those skilled in the art will recognize that other alternative hardware environments may be used without departing from the scope of the present invention. For example the methods presented may be employed in a simulation package (i.e., a software package that simulates a communication system). In such an environment, the probability density functions or cumulative distribution functions may be the result of calculation based upon assumptions and models, as opposed to being the result of measurement.

Various modifications and alterations of this invention will become apparent to those skilled in the art without departing from the scope and spirit of this invention, and it should be understood that this invention is not to be unduly limited to the illustrative embodiments set forth herein.

1. A method of determining a bit error rate in a communication system comprising a transmitter, a medium, and a receiver, the method comprising:
identifying a plurality of causes of bit errors;
measuring the communication system to determine probability density functions, each of which corresponds to one of the plurality of causes of bit errors;
integrating each of the corresponding probability density functions over an interval representing a range in which the corresponding cause creates a bit error, thereby generating a plurality of integrated quantities; and
summing the integrated quantities to arrive at a bit error rate for the communication system.

2. The method of claim 1, wherein the plurality of causes includes a waveform edge transition being tardy.

3. The method of claim 1, wherein the plurality of causes includes a waveform edge transition being premature.

4. The method of claim 1, wherein the plurality of causes includes excessive waveform amplitude.

5. The method of claim 1, wherein the plurality of causes includes insufficient waveform amplitude.

6. The method of claim 1, further comprising:
integrating each of the probability density functions over various intervals, thereby creating a plurality of ordered pairs.

7. The method of claim 6, further comprising:
representing the ordered pairs on a display, to present a surface depicting the bit error rate as a function of the plurality of causes of bit errors.

8. The method of claim 1, wherein measuring the communication system to determine a corresponding probability density function includes the step of fitting a portion of a partially measured probability density function to a known function to arrive at a complete probability density function.

9. The method of claim 8, wherein the known function is a gaussian function.

10. The method of claim 8, wherein the portion of the partially measured probability density function is a tail portion.

11. The method of claim 1, wherein measuring the communication system to determine a corresponding probability density function includes the step of fitting a portion of a partially measured cumulative distribution function to a known function to arrive at a complete cumulative distribution function.

12. The method of claim 11, wherein the known function is an error function.

13. The method of claim 11, wherein the portion of the partially measured cumulative distribution function is a tail portion.

14. The method of claim 1, wherein measuring the communication system to determine a corresponding probability density function includes measuring the system to arrive at a cumulative distribution function, and taking the derivative of the measured cumulative distribution function to arrive at the corresponding probability density function.

15. An apparatus for determining a bit error rate in a communication system, the apparatus comprising:
(a) a measurement apparatus for measuring the communication system to determine probability density functions corresponding to a plurality of causes of bit errors; and
(b) an analyzing unit, operatively connected to the measurement apparatus, for integrating each of the probability density functions over an interval representing a range in which the corresponding cause creates a bit error, thereby generating a plurality of integrated quantities, and summing the integrated quantities to arrive at a bit error rate for the communication system.

16. The apparatus of claim 15, wherein the measurement apparatus measures occurrences of waveform edges transition being tardy.

17. The apparatus of claim 15, wherein the measurement apparatus measures occurrences of waveform edges transition being premature.

18. The apparatus of claim 15, wherein the measurement apparatus measures occurrences of excessive waveform amplitude.

19. The apparatus of claim 15, wherein the measurement apparatus measures occurrences of insufficient waveform amplitude.

20. The apparatus of claim 15, wherein the analyzing unit is further configured and arranged to integrate each of the probability density functions over various intervals, thereby creating a plurality of ordered pairs.

21. The apparatus of claim 20, wherein the analyzing unit is further configured and arranged to represent the ordered pairs on a display, to present a surface depicting the bit error rate as a function of the plurality of causes of bit errors.

22. The apparatus of claim 15, wherein the analyzing unit is further configured and arranged to fit a portion of a partially measured probability density function to a known function to arrive at a complete probability density function.

23. The apparatus of claim 22, wherein the known function is a gaussian function.

24. The apparatus of claim 22, wherein the portion of the partially measured probability density function is a tail portion.

25. The apparatus of claim 15, wherein the analyzing unit is further configured and arranged to fit a tail portion of a partially measured cumulative distribution function to a known function to arrive at a complete cumulative distribution function.

26. The apparatus of claim 25, wherein the known function is an error function.

27. The apparatus of claim 25, wherein the portion of the partially measured cumulative distribution function is a tail portion.

28. The apparatus of claim 15, wherein the analyzing unit is further configured and arranged to take the derivative of a measured cumulative density function to arrive at a probability density function.

29. An article of manufacture comprising a program storage medium readable by a computer having a memory, the medium tangibly embodying one or more programs of instructions executable by the computer to perform method steps for performing operations to arrive at a bit error rate for a communication system, the method comprising the steps of:
for each of a plurality of causes of bit errors, measuring the communication system to determine a corresponding probability density function;
integrating each of the corresponding probability density functions over an interval representing a range in which the corresponding cause creates a bit error, thereby generating a plurality of integrated quantities; and
summing the integrated quantities to arrive at a bit error rate for the communication system.

30. The article of manufacture of claim 29, wherein the plurality of causes of bit error rates includes amplitude jitter and timing jitter.

31. A method of determining a bit error rate in a hypothetical communication system, the method comprising:
identifying a plurality of causes of bit errors;
obtaining probability density functions, each of which corresponds to one of the plurality of causes of bit errors;
integrating each of the corresponding probability density functions over an interval representing a range in which the corresponding cause creates a bit error, thereby generating a plurality of integrated quantities; and
summing the integrated quantities to arrive at a bit error rate for the communication system.

32. A method of determining a bit error rate in a communication system, the method comprising:
identifying a plurality of causes of bit errors;
obtaining cumulative distribution functions, each of which corresponds to one of the plurality of causes of bit errors;
obtaining probability values from the cumulative distribution functions, the probability values corresponding to degrees of corresponding causes sufficient to create a bit error; and
summing the probability values to arrive at a bit error rate for the communication system.

33. A method of determining a bit error rate in a hypothetical communication system, the method comprising:
identifying a plurality of causes of bit errors;
obtaining cumulative distribution functions, each of which corresponds to one of the plurality of causes of bit errors;
obtaining probability values from the cumulative distribution functions, the probability values corresponding to degrees of corresponding causes sufficient to create a bit error; and
summing the probability values to arrive at a bit error rate for the communication system.
